(19) United States
(12) Patent Application Publication
(10) Pub. No.: US 2006/0024042 A1
(43) Pub. Date: Feb. 2, 2006

(54) Photo-manager

(76) Inventor: Fang Wei-Chou, Peiching City (CN)

Correspondence Address: BIRCH STEWART KOLASCH & BIRCH, PO BOX 747, FALLS CHURCH, VA, 22040-0747, US

(21) Appl. No.: 10/900,375

(22) Filed: Jul. 28, 2004

(51) Int. Cl. G03B 17/24

(52) U.S. Cl. 396/312

(57) ABSTRACT

A photo-manager for recording/playing audio signal is provided. The photo-manager comprises an identifying device, for identifying an identification code of a photo; a micro-controller, connected to the identifying device; an audio recorder/player chip, connected to an audio device, for storing the recording/playing audio signal, wherein when the identifying device identifies the identification code of the photo and transmits the identification code to the micro-controller, the micro-controller locates an address corresponding to the identification code stored in the audio recorder/player chip to play the audio signal corresponding to the address via said audio device or an audio data received by the audio device is stored in the corresponding address.

### BACKGROUND OF THE INVENTION

1. The Field of the Invention

The present invention generally relates to a photo-manager with audio playing and recording functions, and more particularly to photo-manager comprising an identifying device adapted for identifying an identification code of a photo and transmitting the code to a micro-controller where the micro-controller locates a corresponding address from an audio recorder/player chip according to the identification code in order to play the audio signal stored at the address using an audio device or store the audio signal received by the audio device into the address. Thus, the user can record various sound signal related to photos without using other storage devices and thereby reducing the cost and make the product very attractive to users.

2. Description of Related Art

Presently, new technologies are rapidly being developed with view of providing more convenience to users and improve efficiency. For example, the technology developed from development of camera in the olden days to video camera and further to latest digital video camera allowing users to record and store the text/image data as pleasant memories. However, digital video camera requires other hi-tech products to coordinate with to play the recorded data, such as the computer, and therefore the cost is high. Furthermore, video camera captures motion images consisting of a plurality of serial frame images, which cannot be converted into still pictures, and that users can view motion picture on the monitor using video player. For preserving any interesting images as a memory, a user may choose to use a camera to capture these images in a film and develop the film to obtain photos that can be viewed anytime, and such convenience to users is indispensable. However, the drawback is that the camera cannot express the feeling or the situation at the time of capturing the picture. Accordingly, some manufactures proposed to develop a product including a photo frame with the audio player and recorder for providing sound output and recording functions. Referring to FIGS. 6 and 7, the frame A comprises a space A1 for placing the photo and a circuit board B is disposed inside the frame A. The circuit board B comprises an audio processor B1, a DRAM B2, a sound receiver B3, an amplifier B4, a speaker B5, a touch mode switch B6 and an extended recording button A2. When the user presses the recording button A2, the sound signal is transmitted via the sound receiver B3 to the audio processor B1 where it is converted into the digital signal and stored into the DRAM B2. When the user touches the touch mode switch B6, the audio play function is activated for converting the audio digital signal into the audio analog signal and the sound is output via the amplifier B4 to the speaker B5.

However, the conventional touch mode photo frame product with the audio recorder and player functions described above has several defects as follows.

Only one audio signal for one photo can be stored and played, and it is usual for users desiring to have more photos, which would require more frames for storing corresponding audio signal and therefore not cost effective.

The audio signal recorded cannot change according to the photo, and therefore the user has to redo the recording when changing the photo. Accordingly, it provides inconvenience to the users and cannot be commercially attractive on the market.

Therefore, to overcome the above defects is an important issue to the manufacturer in the field.

### SUMMARY OF THE INVENTION

Accordingly, in the view of the foregoing, the present inventor makes a detailed study of related art to evaluate and consider, and uses years of accumulated experience in this field, and through several experiments, to create a new photo-manager. The present invention provides an innovated cost effective photo-manager for providing more convenience to users.

According to an aspect of the present invention, an identifying device is adapted for identifying an identification code of a photo and for transmitting the identification code to a micro-controller, and the micro-controller locates the corresponding address from a audio recorder/player chip according to the identification code in order to play the audio signal stored at the address through an audio device or the audio signal received by the audio device is stored in the address. Accordingly, users may record various sound data related to the photos without requiring other storage devices, and therefore the photo-manger according to an embodiment of the present invention is comparatively inexpensive and more attractive on the market.

It would be more relevant and appropriate to parallel the current invention with the photo album whether a talking or convention non-talking photo album. The key feature of the current invention is giving each photo an ID, thereby providing these advantages.

1. Unlike conventional talking photo album, the current invention does not require individual photo to be assembled together, each photo can be recorded and playback independent of others.

2. The photo can be stored randomly or arranged in any order and category.

3. Numbers of photos are expandable.

### BRIEF DESCRIPTION OF THE DRAWING

For a more complete understanding of the present invention, reference will now be made to the following detailed description of preferred embodiments taken in conjunction with the following accompanying drawings.

FIG. 1 is a flowchart of a photo-manager according to an embodiment of the present invention.

FIG. 2 is an exemplary photo according to an embodiment of the present invention.

FIG. 3 is an elevational view of a photo-manager according to an embodiment of the present invention.

FIG. 4 is a flowchart illustrating a procedure of playing audio data according to an embodiment of the present invention.

FIG. 5 is a flowchart illustrating a procedure of recording audio data according to an embodiment of the present invention.

FIG. 6 is an elevational view of a conventional touch mode photo frame product.

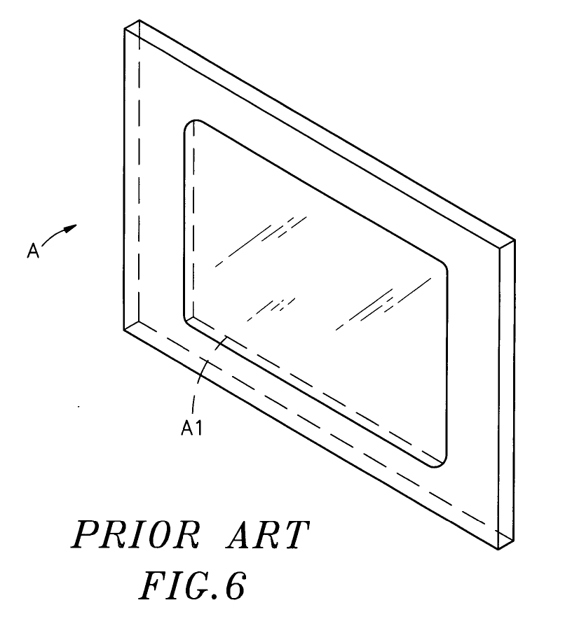

FIG. 7 is a flowchart illustrating an operation of a conventional touch mode photo frame product.

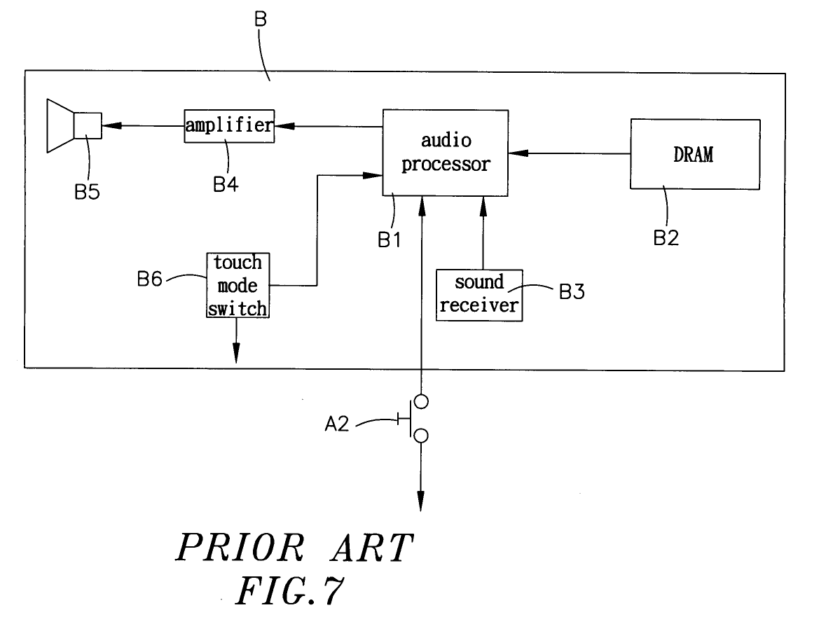

### DETAILED DESCRIPTION OF PREFERRED EMBODIMENTS

Reference will be made in detail to the preferred embodiments of the invention, examples of which are illustrated in the accompanying drawings. Wherever possible, the same reference numbers are used in the drawings and the description to refer to the same or like parts.

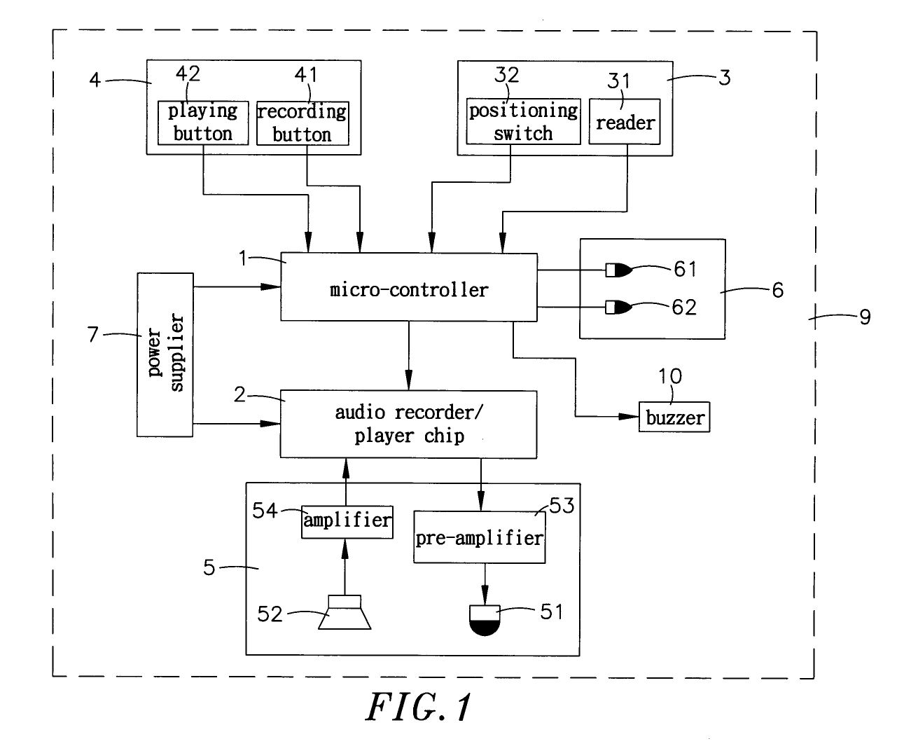

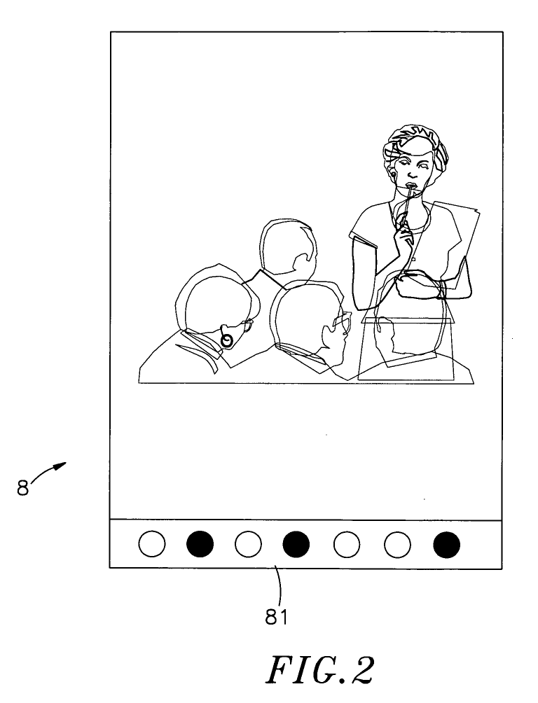

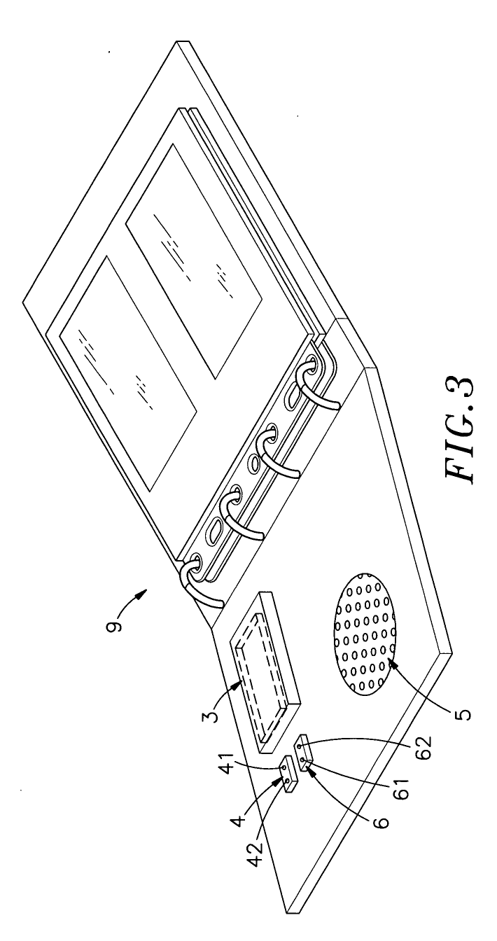

Referring to FIGS. 1, 2 and 3, the photo-manager comprises a micro-controller 1, an audio recorder/player chip 2, an identifying device 3, a controller 4, an audio device 5, an indication device 6, a power supplier 7, photos 8, a manager device 9 and a buzzer 10.

The manager device 9 according to an embodiment of the present invention is adapted for receiving and managing the photos 8.

The micro-controller 1 according to an embodiment of the present invention is installed in the manager device 9 and is adapted for receiving an identification code 81 of each photo 8 identified by the identification device 3 and for locating storage address corresponding to the identification code 81 in the audio recorder/player chip 2.

The audio recorder/player chip 2 according to an embodiment of the present invention is connected to the micro-controller 1 and is adapted for storing or playing the audio signal.

The identifying device 3 according to an embodiment of the present invention is connected to the micro-controller 1 and comprises a reader 31 for reading an identification code 81 of each photo 8 and a positioning switch 32 for sensing whether or not the photos 8 are in correct position.

The controller 4 according to an embodiment of the present invention is connected to the micro-controller 1. The controller 4 comprises a recording button 41 and the playing button 42. The recording button 41 and the playing button 42 are adapted for giving command to the audio recorder/player chip 2 for recording/playing the audio signal.

The audio device 5 according to an embodiment of the present invention comprises a microphone 51 and a speaker 52 connected to the audio recorder/player chip 2 via pre-amplifiers 53 and amplifiers 54 respectively.

The indication device 6 according to embodiment of the present invention is connected to the micro-controller 1 and comprises the playing indicator 61 and the recording indicator 62 for displaying the operation status.

The power supplier 7 according to an embodiment of the present invention is connected to the micro-controller 1 and the audio recorder/player chip 2 and is adapted for supplying the power needed for operating the photo-manager.

The buzzer 10 according to an embodiment of the present invention is connected to the micro-controller 1, wherein when an error occurs, for example, due to an unidentifiable code, the micro-controller 1 enables the buzzer 10 for outputting a warning sound.

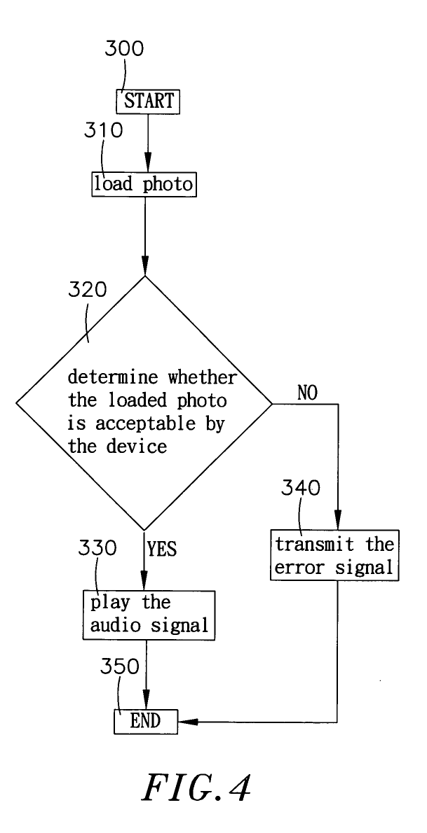

Hereinafter, procedure for playing the audio signal according to an embodiment of the present invention will be described with reference to FIGS. 1, 2 and 4 as follows:

at step 300, the procedure starts;

at step 310, the photo 8 is placed into the identifying device 3 such that the photo contacts the positioning switch 32, and the reader 31 reads the identification code 81 of the photo 8;

at step 320, the identification code 81 read by the identifying device 3 is transmitted to the micro-controller 1 where whether or not the identification code 81 is acceptable by the manager device 9 is judged, wherein when it is judged that the identification code 81 is acceptable, the procedure proceeds to step 330 and if not, the procedure proceeds to step 340;

at step 330, the micro-controller 1 transmits the identification code 81 to the audio recorder/player chip 2 for playing the audio signal corresponding to the identification code 81 via the amplifier 54 to the speaker 52, and meanwhile, the micro-controller 1 turns on the playing indicator 61 of the indication device 6.

at step 340, the micro-controller 1 sends an error signal to activate the buzzer 10 to output a warning sound; and

the procedure ends at step 350.

Furthermore, when there is no photo 8 and the user executes the audio player function by pressing the playing button 42, the micro-controller 1 replays the audio signal according to the previously stored address.

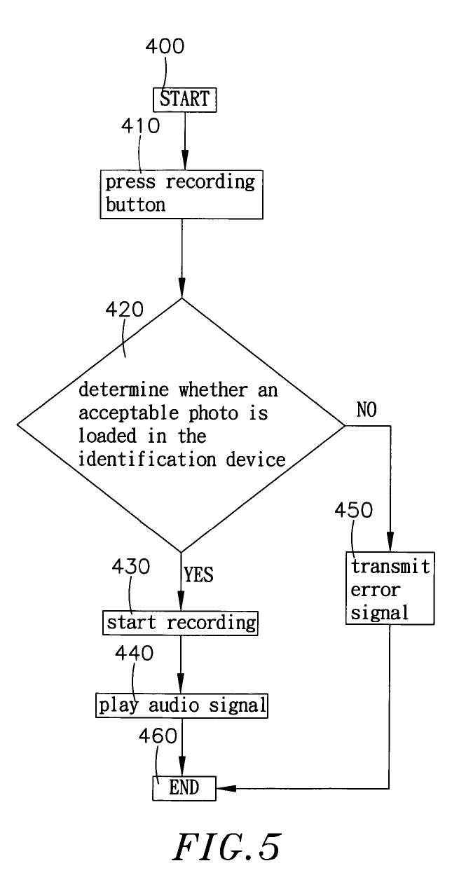

Hereinafter, the procedure of recording audio signal according to an embodiment of the present invention will be described with reference to FIGS. 1, 2 and 5 as follows:

at step 400, the procedure starts;

at step 410, the recording button 41 is activated;

at step 420, whether any acceptable photo 8 in the identifying device 3 is determined, when an acceptable photo 8 is determined in the identifying device 3, the procedure proceeds to step 430 and if not, the procedure proceeds to step 450;

at step 430, the micro-controller 1 transmits the identification code 81 to the audio recorder/player chip 2 and the recording indicator 62 of the indication device 6 is turned on at the same time, the audio signal received by the microphone 51 is transmitted via the pre-amplifier 53 to the audio recorder/player chip 2 and the audio recorder/player chip 2 stores the audio signal in the address corresponding to the identification code 81;

at step 440, after the recording is completed, the micro-controller 1 turns off the recording indicator 62 of the indication device 6 and the audio recorder/player chip 2 plays the audio signal stored in the address corresponding to the identification code 81 via the amplifier 54 to the speaker 52, and the procedure proceeds step 460;

at step 450, the micro-controller 1 sends an error signal to activate the buzzer 10 to output a warning sound; and

the procedure ends at step 460.

Further, the latest data stored overwrites the previously recorded data.

And, the reader 31 according to an embodiment of the present invention can be a barcode reader, an optical sensor, a mechanical card reader or an electrical carbon or conductive copper foil reader.

According to an aspect of the present invention, the identifying device 3 is adapted for reading the identification code 81 of the photo 8, which is then transmitted to the micro-controller 1 where the storage address stored in the audio recorder/player chip 2 corresponding to the identification code 81 is located and the audio signal is output via the audio device 5. The micro-controller 1 is also adapted for storing the audio signal received by the audio device 5 into the corresponding address, and therefore the audio signal can be altered according to the photos and the sound signal for different photos can be output without requiring any other storage device. Accordingly, the photo-manager of the present invention is substantially inexpensive compared to the conventional touch mode photo frame product.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What the invention claimed is:

1. A photo-manager, comprising:
an identifying device, for identifying an identification code of a photo;
a micro-controller, connected to said identifying device;
an audio recorder/player chip, connected to an audio device, for recording/playing audio signal stored therein, wherein when said identifying device identifies said identification code of said photo and transmits said identification code to said micro-controller, said micro-controller locates an address corresponding to said identification code stored in said audio recorder/player chip to play an audio signal corresponding to said address via said audio device or an audio signal received by said audio device is stored in said corresponding address.

2. The photo-manager according to claim 1, wherein said identifying device comprises a reader and a positioning switch.

3. The photo-manager according to claim 2, wherein said reader comprises a barcode reader.

4. The photo-manager according to claim 2, wherein said reader comprises an optical sensor.

5. The photo-manager according to claim 2, wherein said reader comprises a mechanical card reader.

6. The photo-manager according to claim 2, wherein said reader comprises an electrical carbon or conductive copper foil reader.

7. The photo-manager according to claim 1, wherein said identification code comprises a barcode.

8. The photo-manager according to claim 1, wherein said identification code comprises an optical coded aperture.

9. The photo-manager according to claim 1, wherein said identification code comprises a mechanical card.

10. The photo-manager according to claim 1, wherein said identification code comprises an electrical carbon or conductive copper foil.

11. The photo-manager according to claim 1, wherein said manager device comprises a photo album.

12. A method of playing an audio signal using a photo-manager comprising:
(a) starting said method of playing audio signal in said photo-manager;
(b) placing a photo into an identifying device and reading said identification code of said photo;
(c) transmitting said identification code read by said identifying device to a micro-controller and judging whether said identification code is acceptable by said identifying device, wherein when it is determined that said identification code is acceptable, proceeding to step (d);
(d) transmitting said identification code to said audio recorder/player chip for playing audio signal stored in an address corresponding to said identification code via an audio device; and
(e) ending said method of playing in said photo-manager.

13. A method of recording an audio signal using a photo-manager comprising:
(a) starting said method of recording audio signal in said photo-manager;
(b) pressing said recording button;
(c) judging whether an acceptable photo is loaded in an identifying device of said photo-manager, wherein when it is determined that an acceptable photo is loaded in said identifying device, proceeding to step (d);
(d) transmitting said identification code to said audio recorder/player chip, and storing said audio signal in said audio recorder/player chip to an address corresponding to said identification code;
(e) playing said audio signal stored in said address corresponding to said identification code via said audio device; and
(f) ending said method of recording audio signal in photo-manager.
